(19) United States
(12) Patent Application Publication
(10) Pub. No.: US 2020/0098281 A1
(43) Pub. Date: Mar. 26, 2020

(54) AUTOMATED COMPONENT-BASED STIMULUS GENERATION FOR ADAPTIVE ASSESSMENTS

(71) Applicant: ACT, Inc., Iowa City, IA (US)

(72) Inventor: RICHARD D. MEISNER, Iowa City, IA (US)

(21) Appl. No.: 16/141,936

(22) Filed: Sep. 25, 2018

(51) Int. Cl. G09B 7/00; G06N 99/00

(52) U.S. Cl. CPC G09B 7/00; G06F 3/04842; G06N 99/005

(57) ABSTRACT

A comprehensive assessment is generated from sources of information. A base stimulus on a broad topic is received, wherein the base stimulus consists of components in the sources of information. Shorter stimuli are generated by selecting components from the base stimulus. The base stimulus may contain content for any type of subject, wherein the content is any combination of text, numbers, tables, charts, figures, audio clips, video clips, etc. The components for each sub-stimulus can be selected and rearranged based on examinee's performance and ability.

### TECHNICAL FIELD

The disclosed technology relates generally to creating and administering computer-based adaptive assessments. More particularly, various embodiments relate to systems and methods for managing computer-based generation of stimuli for adaptive assessments.

### BACKGROUND

Standardized examinations are a type of assessment used for evaluating the competency of students and/or professionals. To have continuing value, the assessment should deliver sets of questions to examinees with deliberate levels of difficulty across similar knowledge bases and/or categories of information, while still varying the specific content of the stimuli and questions. This balance enables the assessments to be standardized, such that they determine consistently the competence of individual examinees, while providing for new and unique content to reduce the possibility that examinees may share information, cheat, or remember questions for repeat examinees, and to keep the assessment fresh. Maintaining this balance requires significant generation of related stimuli from various content sources and limits the relevant useful lifetime and frequency for administering a particular standardized exam or other type of assessments.

Additionally, the responses to the questions in the assessments are evaluated for correctness, wherein the questions are associated with test stimuli. Typically, these evaluations are not adapted to the individual examinee in terms of different question-types, test stimuli-type, and nuances between academic disciplines. For example, science and math-based disciplines are more technical than social science and humanities-based disciplines. Furthermore, examinees vary in skill sets and abilities within disciplines and across disciplines. In turn, these evaluations may not be truly reflective of examinee's performance and achievement, by virtue of test stimuli and different question-types that are not adaptable to the examinee.

### BRIEF SUMMARY OF EMBODIMENTS

A method is disclosed for improving quality and customization of computer-generated stimuli for use in standardized computer-based assessments. The method includes: connecting, by an access logical circuit, to one or more information sources and extracting, by an analytics logical circuit, a set of contents from the one or more information sources; dividing, by a faceting logical circuit, the extracted set of contents into a first number of components and a second number of components, wherein the first number of components is larger than the second number of components. The method may also include extracting, by the faceting logical circuit, one or more questions from the one or more information sources, wherein the extracted one or more questions are directed to the extracted set of contents, receiving, at a first graphical user interface, a base stimulus, wherein the base stimulus contains the first number of components with the topic and a first set of questions of the extracted one or more questions associated with each component of the first number of components, and generating, with the analytics logical circuit, sub-stimuli to the base stimulus, wherein the sub-stimuli contain the second number of components and a second set of questions of the extracted one or more questions associated with each component of the second number of components. The method may also include sending, by an assessment logical circuit, the selected sub-stimulus components and the extracted one or more questions to a second graphical user interface; and displaying, at the second graphical user interface, the selected sub-stimulus components and the second set of questions to examinees.

A computer program product is disclosed for improving the efficiency and customization of generation of stimulus-based assessment pertaining to a topic, based on the automated method above. A computer system is also disclosed for improving the efficiency and customization of generation of stimulus-based assessment pertaining to a topic, based on the automated method above.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any embodiments described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a data processing environment illustrating an example of a network setup supporting automated adaptive generation of stimulus-based assessments, in accordance with the embodiments disclosed herein.

FIG. 2 is a schematic diagram illustrating the components of an assessment module used for automated adaptive generation of stimulus-based assessment, in accordance with embodiments disclosed herein.

FIG. 3 illustrates a schematic flowchart of steps performed and/or facilitated by the assessment module leading to automated adaptive generation of stimulus-based assessment, in accordance with embodiments disclosed herein.

FIG. 4 illustrates an example of a graphical user interface containing stimulus generation parameters, in accordance with embodiments disclosed herein.

FIG. 5 illustrates an example of a broad topic described in terms of components on the broad tropic, in accordance with embodiments disclosed herein.

FIG. 6 illustrates generated stimuli containing different arrangements of components, in accordance with embodiments disclosed herein.

FIG. 7 illustrates an example computing system that may be used in implementing various features of embodiments of the disclosed technology.

The figures are not intended to be exhaustive or to limit the disclosure to the precise form disclosed. It should be understood that embodiments disclosed herein can be practiced with modification and alteration, and that the disclosed technology be limited only by the claims and the equivalents thereof.

### DETAILED DESCRIPTION OF THE EMBODIMENTS

Creating assessments that include testing stimuli and associated questions of varying difficulty for standardized testing is an arduous process. For example, a single standardized test may require a large number of test forms to ensure that examinees are exposed to questions with the appropriate level of difficulty and testing the appropriate knowledge, while not presenting examinees with the same exact stimuli. Accordingly, a large number of stimuli seeking related or similar information must be generated for each standardized test, even when there are relatively few questions in the examination as a whole. This problem is compounded when considering that over time, additional stimuli must be used and/or created to avoid repeating the same questions to an examinee who may take the examination multiple times, or may have access to information about previously presented stimuli, for example, as collected by test preparation companies or disseminated through social media or on the Internet.

Embodiments of the present disclosure may enable the creation of a large number of high-quality stimuli, including groups of related stimuli for standardizing testing purposes, by utilizing a sub-setting approach for automated generation of stimulus-based assessments. Further, methods and systems disclosed herein may apply a combinatorial approach for automatic generation of large numbers of distinct shorter stimuli by sub-setting combinations of components from the larger set of components comprising the longer stimulus. For example, in one non-limiting example, a standardized test may require on the order of 3000 unique 5-component stimuli, which in turn, may require generation of on the order of 3000 unique human stimulus-writing assignments. Using a combinational approach disclosed herein, a single human stimulus-writing assignment, containing 15- or 16-components, may be used to generate on the order of 3000 unique 5-component stimuli.

For example, an assessment in chemistry (i.e., a chemistry subject test) contains questions on specific sub-topics of chemistry, such as organic synthesis and quantum mechanics. These questions may be derived from reliable and relevant information sources, such as peer-reviewed chemistry education journals directed to the principles and laboratory experiments of organic synthesis and quantum mechanics. New findings are reported to the peer-reviewed chemistry journals to maintain the accurate and updated information pertaining to chemistry. Thus, the peer-reviewed chemistry education journals maintain relevancy and value as a testing stimulus for an assessment in chemistry. Information sources directed to mathematics or electrical circuits are outside the scope of chemistry. Thus, these sources are not used for the assessment in chemistry or as testing stimuli or the basis for questions presented to the examinee. The testing stimuli may be in text, audio, image, or video formats.

The number of stimuli can easily become much larger. In instances where the order of components needs to be preserved, the number of possible unique stimuli is determined by n combination k (C(n,k)), wherein k is a fixed length from a given set of n elements. In instances where the order of components does not need to be preserved, the number of possible unique stimuli is determined by n permutation k (P(n,k)), wherein k is a fixed length from a given set of n elements. For example, if the starting base stimulus is 30 components long, the number of distinct order-preserving 5-component subsets is 142506. Additionally, if the original developed longer base stimulus is of high quality, the quality can be expected to be preserved in all of the auto-generated shorter stimuli containing a set of components. The set of components are in different formats (e.g., paragraph, table, and chart form) containing a relatively independent focus on a particular subtopic of the broader topic associated with the base stimulus.

Additionally, there is an increasing demand for both adaptive assessment and personalized assessment. The relatively independent focus on the particular subtopic of the broader topic associated with the base stimulus provides common source(s) of information needed to derive the stimuli and questions presented to the examinees. Within the common source, stimuli, and accompanying questions of varying levels of difficulty may be presented on a broader topic to the examinee. Stated another way, a highly flexible and efficient system for adaptively auto-generating stimuli for assessments reutilizes/recycles stimulus content (e.g., the set of components in a base stimulus and generated stimulus). Through user- or algorithm-guided selection of a set of components in the stimulus responsive to the interests and/or learning style and/or ability level of the examinee, adaptive and personalized assessment of the examinee is realized.

In summary, the methods and systems, as described herein, allow for efficient generation/use of assessment stimuli to significantly reduce time, effort, and expense per distinct stimulus to generate shorter stimuli, while at the same time, improving the adaptiveness of the assessment to the examinee, and consistency of those stimuli for purposes of standardized testing. In some embodiments, the combinatorial approach for automatic generation of large numbers of distinct shorter stimuli adapts the shorter stimuli. In turn, the method and systems emphasize: components directed to subject matter deemed most relevant or appropriate to an examinee, e.g., based on the examinee's ability to correctly answer previously delivered stimuli of varying degrees of difficulty, derived from particular categories or knowledge bases, certain format types over other format types in the assessment (e.g., paragraph over chart data), and/or difficulty level of component-associated items.

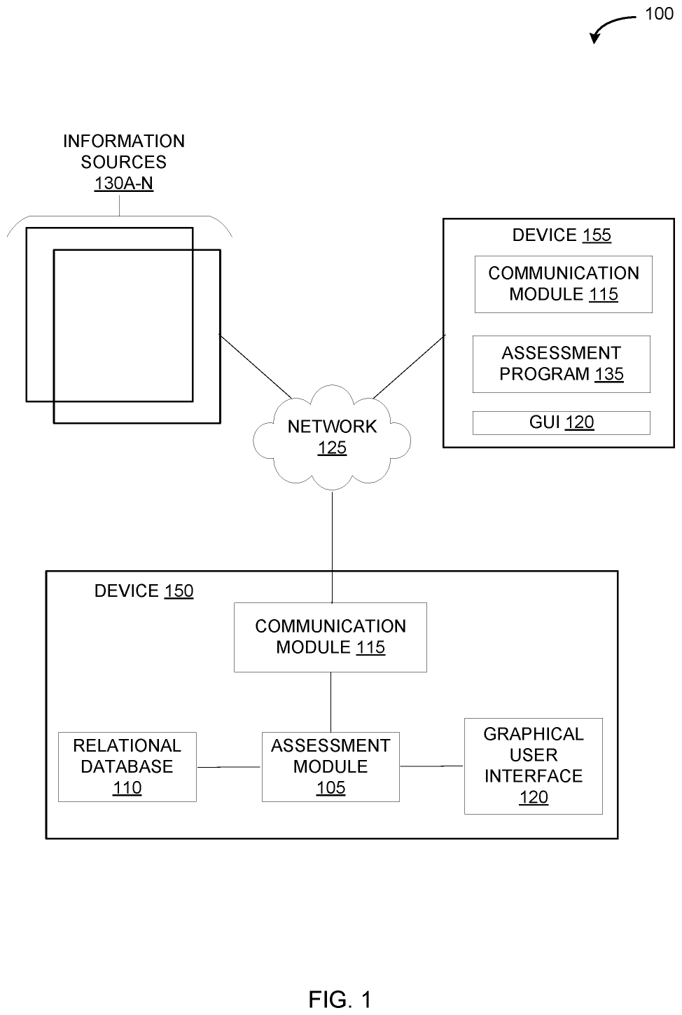

FIG. 1 is a data processing environment illustrating an example of a network setup for supporting automated adaptive generation of stimulus-based assessments. In some embodiments when administering an assessment, environment 100 includes information sources 130A-N, device 150, and device 155 connected to each other via network 125.

Device 150 and device 155 are computing devices, such as a laptop computer, a tablet computer, a netbook computer, a personal computer (PC), a desktop computer, a personal digital assistant (PDA), a smart phone, or any programmable electronic device capable of communicating with each other and information sources 130A-N via network 125. Device 150 is in use by an entity generating the assessment, whereas device 155 is in use by an entity taking the assessment. Both device 150 and device 155 contain communication module 115 and graphical user interface (GUI) 120. In some embodiments, device 150 contains assessment module 105 and relational database 110, which are not contained within device 155. Shorter stimuli and accompanying questions are: (i) generated by assessment module 105 in device 150; and (ii) sent to assessment program 135. Assessment program 135 is a software platform for providing the shorter stimuli and accompanying questions outputted to GUI 120 on device 155. Network 125 may be local area network (LAN); a wide area network (WAN), such as the Internet; the public switched telephone network (PSTN); a mobile data network; a private branch exchange (PDX); any combination thereof; or any combination of connections and protocols that support communications between device 150, device 155, and information sources 130A-N. Network 125 may include wired, wireless, or fiber optic connections.

Communication module 115 is a software or hardware component that receives and sends information from network 125. GUI 120 is a software or hardware component that display text, documents, image, web browser windows, user options, application interfaces, and instructions for operation. In an exemplary embodiment, GUI 120 in device 150 is operatively and/or communicatively connected to assessment module 105 to output an application interface for configuring stimuli parameters during the administration and evaluation of the assessment. In the same exemplary embodiment, GUI 120 in device 155 is operatively and/or communicatively connected to assessment program 135 to output an application interface for presenting the stimuli and associated questions to the examinee. Relational database 110 is a digital database utilizing first-order predicate logic. In some embodiments, assessment module 105 extracts information on a topic from information sources 130A-N and stores the information in relational database 110. In some embodiments, the information stored in relational database 110 is represented in terms of tuples and grouped into relations.

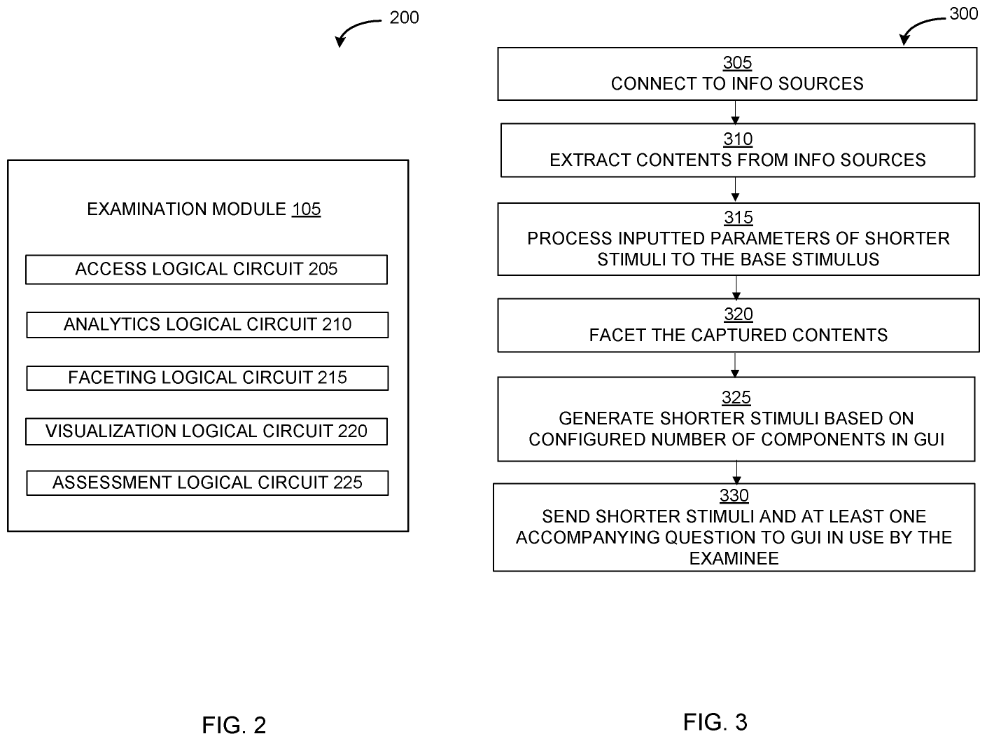

Assessment module 105 may be software patch/program which communicates with relational database 110, communication module 115, and graphical user interface 120 in device 150. In some embodiments, assessment module 105 utilizes and/or invokes logical circuits and engines to perform functions, in accordance with the embodiments of the technology disclosed herein. Example logical circuits are described in more detail with respect to FIG. 2. The combination of these logical circuits in assessment module 105 may provide automated adaptive generation of stimulus-based assessments utilizing machine learning and encryption techniques.

For example, machine learning techniques, e.g., a convolutional neural network (CNN), decision tree, linear regression, or other type of machine learning algorithms, may be implemented by assessment module 105. In some examples, the machine learning algorithm may be trained using a training data set. The training data set may be generated by compiling content from information sources 130A-N. The training data set may also include stimuli created from user input provided through a graphical user interface and/or by scanning stimuli generated on paper sources. The training stimuli may be associated with the respective training content from information sources 130A-N from which the respective training stimuli were created. In some examples, multiple training stimuli may be generated from the same individual training content source. The machine learning model may then be trained using large quantities (hundreds or thousands) of training data. During the training process, user input may be obtained to adjust model parameters to increase the efficiency at generating stimuli sets while meeting the adaptiveness for assessments. In some embodiments, after being trained, the machine learning model may then be applied to additional content to generate a stimuli set related to the additional content.

In some embodiments, assessment module 105 applies machine learning and encryption techniques on the contents of information sources 130A-N. For example, machine learning is used to examine and collect statistics or informative summaries of contents across information sources 130A-N and trigger metadata creation to understand the relevance, quality, and structure of the information/data contained within information sources 130A-N. Information sources 130A-N contain information in different formats. Subsequently, data quality procedures of the machine learning techniques, as applied by assessment module 105, eliminate duplicate information, match common records, standardize formats, and extracts the contents residing within information sources 130A-N as sub-topics deemed relevant to a broader topic. The sub-topics, which are accompanied with questions of varying difficulty, are treated as set of components to the broader topic. Furthermore, each set of components is a shorter stimulus to the base stimuli of the broader topic.

In some embodiments, information sources 130A-N are sources containing information pertaining to a topic and accompanying sub-topics of the topic, e.g., articles, encyclopedias, treatises, test books, dictionaries, online data repositories, publicly available official data sources, papers, content repositories, Wikipedia articles, text books, academic publications, multimedia files, and/or data corpuses. The topic may be extracted from an information bank 130A by assessment module 105 to serve as the base stimulus. The accompanying sub-topics to the base stimulus are components which construct the topic. The information sources 130A-N may contain data in the following formats: text, numerical, visual, auditory, or any combination thereof. Assessment module 105 analyzes the contents across these sources to sort through, identify, and distinguish paragraphs containing text, chart, pictures, video, audio, tables, etc. from each other. Furthermore, assessment module 105 extracts questions that may be based on the contents of information sources and associates the questions to the contents of information sources. For example, the contents extracted from a Wikipedia article, a history textbook, and an educational video on the “Scottish Enlightenment” is the topic treated as a base stimulus.

Machine learning or other classification techniques, as applied by assessment module 105, on the extracted contents from the Wikipedia article, the philosophy textbook, and the educational video identifies and treats “St. Andrews”; “Edinburgh”; “Glasgow”; “Aberdeen”; “Robert Burns”; “Adam Smith”; “William Cullen”; “John Leslie”; “James Hutton”; and “David Hume” as 10 relevant sub-topics on the topic of “Scottish Enlightenment. These relevant sub-topics are the components to the base stimulus. Based on a preconfigured number of components inputted in GUI 120 run by assessment module 105, the relevant sub-topics of the base stimulus are organized and re-organized into shorter stimuli with accompanying questions. For example, if the preconfigured number of components is “3” among the 10 relevant sub-topics to the base stimulus of “Scottish Enlightenment”, there are 120 possible arrangements of shorter stimuli (i.e., C(10,3)) generated by assessment module 105. In some embodiments, assessment module 105 analyzes the components for length and language. Machine learning, based on preconfigured settings, are used by assessment module 105 to remove contents from the contents. For example, the “Edinburgh” contains paragraphs in text format summarizing the intellectual interests of different academics affiliated with the “Edinburgh [School of Thought]”; and debates on religion in the Edinburgh campus, during the “Scottish Enlightenment”. The text pertaining to the debates on religion on the Edinburgh campus, while relevant to the “Edinburgh” component, is removed, to limit the subject matter in the “Edinburgh” component to the intellectual interests of different academics at the time. In some embodiments, assessment module 105 may evaluate an examinee on different facets simultaneously, such as proficiency in a foreign language and level of knowledge in the base stimulus based on the arrangements of stimuli. For example, some of the components for the “Scottish Enlightenment” are presented in French and the rest of the components are presented as combination of text in paragraphs, information in charts, and images as maps.

In some embodiments, information sources 130A-N may contain profiles of the examinees. The profiles of examinees include an examinee's previous testing history, performance on exams, breakdown of the performance on questions across different assessments, and preference for question-types. In turn, assessment module 105 identifies trends in profiles of examinees indicative of subject matter of interest to the examinee. In some embodiments, assessment module 105 applies machine learning techniques on information sources 130A-N as an interest filter. The interest filter sorts through base stimuli and accompanying shorter stimuli. Based on the sorting results, the subject matter of the base stimulus and short stimuli of interest to the examinee are generated. For example, an examinee profile A for examinee A indicates that examinee A scores better on reading comprehension questions than science questions and is interested in applying to liberal arts schools. Additionally, examinee A has scored in the 99th percentile on exams with a disproportionate amount of reading comprehension questions pertaining to European history. Thus, the machine learning techniques, as applied by assessment module 105, determine that examinee A would be interested in the base stimulus of the “Scottish Enlightenment”, which is within the subject matter scope of European history, in contrast to quantum mechanics. Additionally, the shorter stimuli and accompanying questions from the base stimulus, as presented to examinee A, may be of higher difficulty level based on the high marks achieved by examinee A on the exams with the disproportionate amount of reading comprehension questions pertaining to European history.

In some embodiments, assessment module 105 extracts the contents from information bases 130A-N. These contents include the base stimulus; shorter stimuli; questions associated with the shorter stimuli; a set of components associated with the base stimulus; a set of components associated with the shorter stimuli, wherein the set of components associated with the shorter stimuli less is than the set of components associated with the base stimulus; and profiles of the examinees, wherein the profiles of examinees are the basis for identifying preferences and abilities of the examinees. In some embodiments, assessment module 105 performs the functions of: (i) transforming the extracted contents into a common/proper format for the purposes of querying, further analysis, and further processing; (ii) loading the transformed and extracted contents to relational database 110; (iii) encrypting the loaded contents in relational database 110 by encoding the loaded contents as a message with a cipher key; and (iv) generating ciphertext containing the shorter stimuli and accompanying stimuli for each examinee.

In some embodiments, assessment module 105 uses indexes to identify and link: (i) components among the set of components in the shorter stimuli; and (ii) questions accompanying a component, as stored in relational database 110. The arrangement of components in the short stimuli and accompanying questions in relational database 110 may be reorganized by assessment module 105, based on determined examinee preferences and abilities. Each possible arrangement of components in the short stimuli and accompanying questions may be associated with examinee(s) using device 155, wherein each arrangement in relation database 110 is encrypted by assessment module 105. Encryption is used to validate an examinee among a plurality of examinees and guard against outputting the shorter stimuli and accompanying questions to an unauthorized examinee. Each respective ciphertext is associated with a different examinee to be validated to ensure the relevant shorter stimuli and accompanying questions are sent to correct examinee. In some embodiments, assessment module 105 decrypts the respective ciphertext to output the shorter stimuli and accompanying questions as intelligible content to assessment program 135 in device 155 via the cipher key, when the shorter stimuli and accompanying questions are sent to and validated by the examinee. More specifically, the contents of the shorter stimuli and accompanying questions, which has been sent to assessment program 135, are outputted to GUI 120 in device 155 upon assessment module 105 decrypting the respective ciphertext.

As noted above, the “Scottish Enlightenment” example is the base stimulus containing 10 components divided into 3 components in the shorter stimuli yielding 120 possible arrangements of the shorter stimuli. For example, a first stimulus among the 120 possible arrangements is “Adam Smith”; “Edinburgh”; and “David Hume”; and a second stimulus among the 120 possible arrangements is “James Hutton”, “William Cullen”, and “John Leslie”. The first stimulus and accompanying questions are associated with Examinee A; and a first cipher key is associated with the first stimulus and accompanying questions for validating Examinee A. The second stimulus and accompanying questions are associated with Examinee B; and a second cipher key is associated with the second stimulus and accompanying questions for validating Examinee B. Examinee A is interested in philosophy and thus, presented with “Adam Smith”, “David Hume”, and “Edinburgh”. These components are directed to either philosophers or school of thoughts during the “Scottish Enlightenment”. In contrast, Examinee B is interested in the history of science and thus, presented with “James Hutton”, “William Cullen”, and “John Leslie”. These components are directed to Scottish scientists during the “Scottish Enlightenment”. The first cipher key is validated by Examinee A; and the second cipher key is validated by Examinee B. Thus, Examinee A views the first stimulus with the accompanying questions sent to assessment program 135, at GUI 120 in device 155; and Examinee B views the second stimulus with the accompanying questions sent to assessment program 135, at GUI 120 in device 155.

FIG. 2 is an example of a schematic diagram illustrating the components of an assessment module used for automated adaptive generation of stimulus-based assessment. As described above, the logical circuits in assessment module 105, e.g., including a processor and a non-volatile memory with computer executable instructions embedded thereon, as depicted in system 200. The computer executable instructions may be configured to cause the processor to perform the functions in the different logical circuits in assessment module 105. More specifically, access logical circuit 205; analytics logical circuit 210; faceting logical circuit 215; visualization logical circuit 220; and assessment logical circuit 225 reside within assessment module 105. These logical circuits perform functions that allow assessment module 105 to generate standardized assessment accounting for different testing abilities and preferences of examinees, while automating standardized assessments.

As used herein, the terms logical circuit and engine might describe a given unit of functionality that can be performed in accordance with one or more embodiments of the technology disclosed herein. As used herein, either a logical circuit or an engine might be implemented utilizing any form of hardware, software, or a combination thereof. For example, one or more processors, controllers, ASICs, PLAs, PALs, CPLDs, FPGAs, logical components, software routines or other mechanisms might be implemented to make up an engine. In implementations, the various engines described herein might be implemented as discrete engines or the functions and features described can be shared in part or in total among one or more engines. In other words, as would be apparent to one of ordinary skill in the art after reading this description, the various features and functionality described herein may be implemented in any given application and can be implemented in one or more separate or shared engines in various combinations and permutations. Even though various features or elements of functionality may be individually described or claimed as separate engines, one of ordinary skill in the art will understand that these features and functionality can be shared among one or more common software and hardware elements, and such description shall not require or imply that separate hardware or software components are used to implement such features or functionality.

Assessment module 105 may include access logical circuit 205. Access logical circuit 205 may be a logical circuit configured to connect device 150 to device 155 and information sources 130A-N. More specifically, access logical circuit 205 invokes communications module 115 to establish connections that: (i) extract contents from information sources 130A-N; and (ii) send shorter stimuli and accompanying questions to assessment program 135.

Assessment module 105 may include analytics logical circuit 210. Analytics logical circuit 210 may be a logical circuit configured to: (i) compile the extracted contents from information sources 130A-N; (ii) identify components within a base stimulus; (iii) arrange and rearrange some of the components in the base stimulus as shorter stimuli; (iv) associate questions with the identified components; (v) determine whether the preferred formats of the examinees are contained in the components; and (vi) associate respective examinees with respective shorter stimuli, based on preferred formats of the examinees.

Assessment module 105 may include faceting logical circuit 215. Faceting logical circuit 215 may be a logical circuit configured to: (i) store the different arrangements of the shorter stimuli; (ii) store the associated/accompanying questions to the components of the shorter stimuli; and (iii) store and process encryption of each examinee. More specifically, faceting logical circuit 205 invokes relational database 110 to perform the storing functions described above.

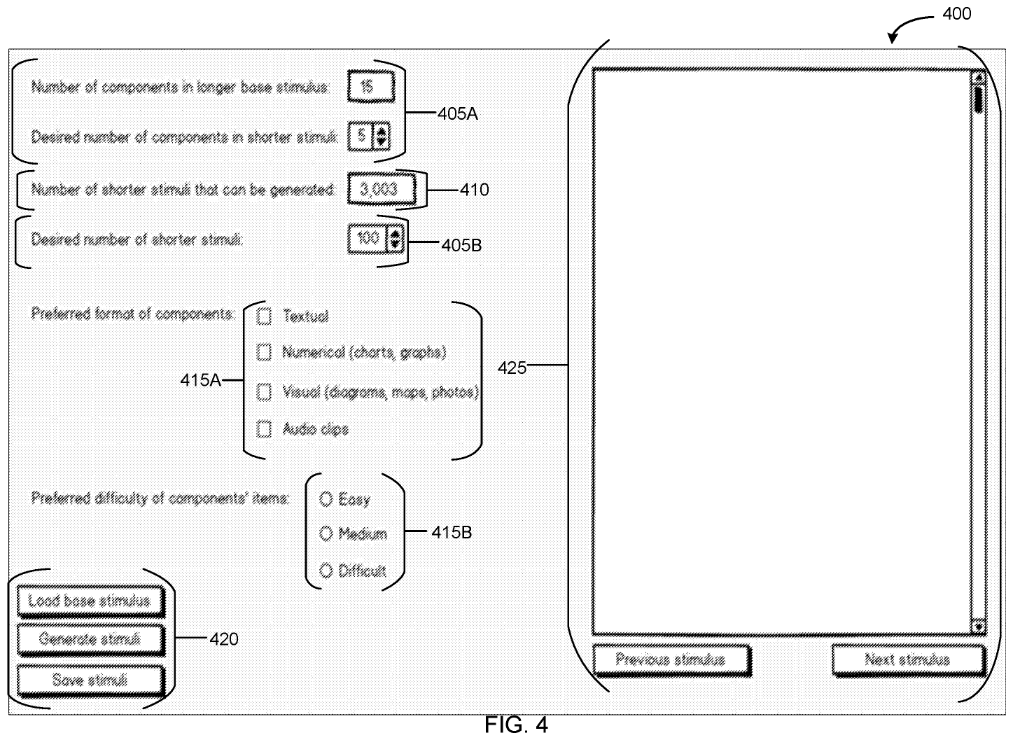

Assessment module 105 may include visualization logical circuit 220. Visualization logical circuit 220 may be a logical circuit configured to provide a GUI, such as GUI 120 in device 150. The GUI in device 150, which receives the components parameters to generate the shorter stimuli, is described in more detail with respect to FIG. 4.

Assessment module 105 may include assessment logical circuit 225. Assessment logical circuit 225 may be a logical circuit configured to: (i) encrypt shorter stimuli and accompanying questions; (ii) send the shorter stimuli and accompanying questions to an examinee, wherein the examinee is using assessment program 135 on device 155; and (iii) decrypting the shorter stimuli and accompanying questions, upon the examinee validating credentials to take the exam. Additionally, the decrypted shorter stimuli and accompanying questions are presented on GUI 120 in device 155. The decrypted shorter stimuli and accompanying questions adaptively emphasize: subject matter of the selected stimulus components; format of selected components (e.g., primarily textual, visual, numerical, and auditory formats); and difficulty level of the accompanying questions. As stated above, analytics logical circuit 210 makes determinations on which items are to be emphasized in the shorter stimuli and accompanying questions.

FIG. 3 illustrates a schematic flowchart of steps performed and/or facilitated by the assessment module leading to automated adaptive generation of stimulus-based assessment. More specifically, method 300, as performed by assessment module 105, furnishes a content-efficient system for automated adaptive generation of stimulus-based assessment.

Still referring to FIG. 3, assessment module 105 connects to information sources (e.g., information sources 130A-N), at step 305. In some embodiments, assessment module 105 uses machine learning techniques which treats a stimulus on a broader topic composed of at least ten related shorter components, as a starting point. Each shorter component focuses on a sub-topic of the broader topic, with one or more assessment items based on each of the shorter stimulus components.

Assessment module 105 extracts contents from the information sources (e.g., information sources 130A-N), at step 310. The stimulus components may be any combination of paragraphs of text, tables, charts, figures, diagrams, photographs, audio clips, or video clips. The stimulus may be in any content area and genre, including humanities, social sciences, natural sciences, news articles, and personal narrative.

More specifically, the component selection process for a top-down method of automated stimulus generation of larger numbers of distinct shorter stimuli are obtained via combinatorial mathematics. Assessment module 105 sub-sets combinations of components from the original larger set of components comprising the longer stimulus (i.e., the base stimulus). For example, there are

$$\frac{15 !}{( 5 ! ) ( 10 ! )} = 3 , 003$$

order-preserving ways, and

$$\frac{15 !}{10 !} = 3 \; 60 , 360$$

non-order-preserving ways, to select 5 components from 15 components. Thus, an exceptionally large number of distinct shorter stimuli may be generated from the single base stimulus. If desired, certain sentences, or even whole components, for example, a first introductory component, may remain fixed among the generated shorter stimuli. In this way, the sub-stimuli may be generated to test similar knowledge and at similar levels of difficulty.

Additionally, at step 315, assessment module 105 uses component metadata for component selection that is flexible, personalized, and adaptive to the examinee. The selection of components from the larger base stimulus for the generation of the shorter stimulus could be entirely random in number and nature of selected components. For example, assessment module 105 invokes analytics logical circuit 210 to find preferences of the examinee, based on the nature of the components (e.g., preferring visual or audiovisual components over purely textual components) and difficulty of the components (e.g., preferring selecting components accompanied with easier questions over components accompanied with more difficult questions). The number of components selected from the longer base stimulus for the shorter generated stimulus could be either specified by the user, or determined automatically by assessment module 105, based on examinee ability level as determined by previous examinee performance.

Assessment module 105 processes inputted parameters of shorter stimuli to the base stimulus through a GUI (e.g., GUI 120 in device 150), at step 315. The GUI in device 150 receives the following as input from the user of device 150: (i) a number of components in the base stimulus; (ii) a number of components in shorter stimuli; (iii) a number of desired shorter stimuli; (iv) a selection of a preferred format of components (e.g., textual, numerical, visual, and audio); and (v) a selection of preferred difficulty of questions accompanying the components. The GUI is described in more detail with respect to FIG. 4.

Assessment module 105 facets the captured contents, at step 320. The captured contents, as obtained from information sources 130A-N, may be organized by assessment module 105. For example, the organization may be based on: (i) the subject matter of a base stimulus for generating shorter stimuli; (ii) the number of components selected from the longer base stimulus for the shorter stimuli; (iii) the type of components selected from the base stimulus for generating shorter stimuli (e.g., textual, numerical, visual, and auditory formats, as described in step 315); and (iv) the difficulty level specified in the GUI or as determined by assessment module 105, based on an examinee's performance. In some embodiments, the different arrangements of the components in the shorter stimuli and accompanying questions may be faceted according to respective examinees taking an assessment.

Assessment module 105 generates shorter stimuli based on a configured number of components in the GUI (e.g., GUI 120 in device 150), at step 325. As mentioned above, different possible arrangements of the components in the shorter stimuli and accompanying questions are possible. For example, 5 components among 15 components in the base stimulus may be selected for generating shorter stimuli. Each arrangement may be encrypted and validated by the appropriate examinee, as described above. Other combinations of components and stimuli may be possible.

Assessment module 105 may send shorter stimuli and one or more accompanying questions to the GUI in use by the examinee (e.g., GUI 120 in device 155). Assessment program 135 receives an encrypted version of the shorter stimuli and the at least one accompanying question. A validated examinee decrypts the encrypted version to view the shorter stimuli and the at least one accompanying question in GUI 120 in device 155.

The generated shorter stimuli approach, as described in the embodiments, is quicker, less expensive, and higher volume than manual human stimulus development of each stimulus.

In comparison to generating shorter stimuli, software that generates novel assessment materials based on natural language generation (NLG) techniques are difficult. Additionally, commercial-quality possibilities are limited (e.g., automatic report generation. When NLG goes beyond simply fitting data into report-like templates, the result is usually not of human-quality expository or narrative writing. The required degree of world knowledge and writing skill is too difficult to fully automate with NLG.

In comparison of generating shorter stimuli, a human writing a standard-length “parent passage” combined with software generating novel material for certain variable “slots” in the passage, for example to reading content, would be exceedingly difficult. This approach replaces correct small phrases in the passage with automatically-generated incorrect small phrases from which to then generate items. These small phrases are of minor importance for an assessment. Any changes in any “variable slots” in the passage must continue to cohere to topic, sensibleness, and writing quality with the remainder of the passage. The automatically-generated substantive variations would not maintain the quality needed for the assessment; and the automatic paraphrasing merely provides reworded and very similar passages. Thus, this is a time-intensive and impractical technique for automated assessments in comparison to generating shorter stimuli.

In comparison to generating shorter stimuli, a human writes standard-length “parent passage” and variable “slots” in the passage on the “Scottish Enlightenment” and a software program combines the human-generated elements into other combinations to generate passage variants. These passage variants are not always amenable to replacing portions of the components. In contrast, assessment module 105 is: (i) able to replace portions of the components in the generated shorter stimuli pertaining; and (ii) maintain the quality of the assessment despite editing or replacing portions of the component.

In an example, where a human writes 15 extensive paragraphs in an essay on the “Scottish Enlightenment”, assessment module 105 can automatically generate 3003 passages from 5 paragraphs from the essay. Stated another way, 5 components are selected from the essay containing 15 components. Each of the selected component stands on its own to provide a high-quality assessment experience. If the contents of each component costs $50 per paragraph, 3000 traditionally sourced 5-paragraph essays cost $750000; a single 5-paragraph essay costs $250; and a single 15-paragraph essay from which ˜3000 different 5-paragraph essays may be generated costs $750. Thus, the arrangement of components in the shorter stimuli via assessment module 105, as disclosed herein, would reduce expenses associated with high quality assessments.

FIG. 4 is an example of a graphical user interface containing stimulus generation parameters. GUI 400 is identical or functionally equivalent to GUI 120 in device 150. Assessment module 105 presents this type of interface to a user of device 150. As stated above, device 150 is in use by an entity for generating testing stimuli and developing adaptive assessments. Numeric inputs are received in entry 405A and entry 405B. In entry 405A, the “number of components in longer base stimulus” and “desired number of components in shorter stimuli” are received to calculate the total possible arrangements of combinations of shorter stimuli in output 410 as the “number of shorter stimuli that can be generated”. In this example, 15 components in the top entry box of input 405A and 4 components in the bottom entry box of input 405B is computed as C(15,5) to yield 3003 possible shorter stimuli in output 410. In entry 405B, the “desired number of shorter stimuli” to limit the number of shorter stimuli to be displayed in box 425. Selectable inputs 415A and 415B correspond to the “preferred format of components” and “preferred difficulty of the components' item” (i.e., the accompanying questions to the components), respectively. Buttons 420 are used to “load base stimulus”, “generate stimuli”, and “save stimuli”. It should be appreciated that the GUI illustrated in FIG. 4 is one example embodiment, and other GUI configurations consistent with this disclosure may provide different orientations of objects, different displays of stimuli, and/or different parameters and parameter ranges, consistent with embodiments disclosed herein.

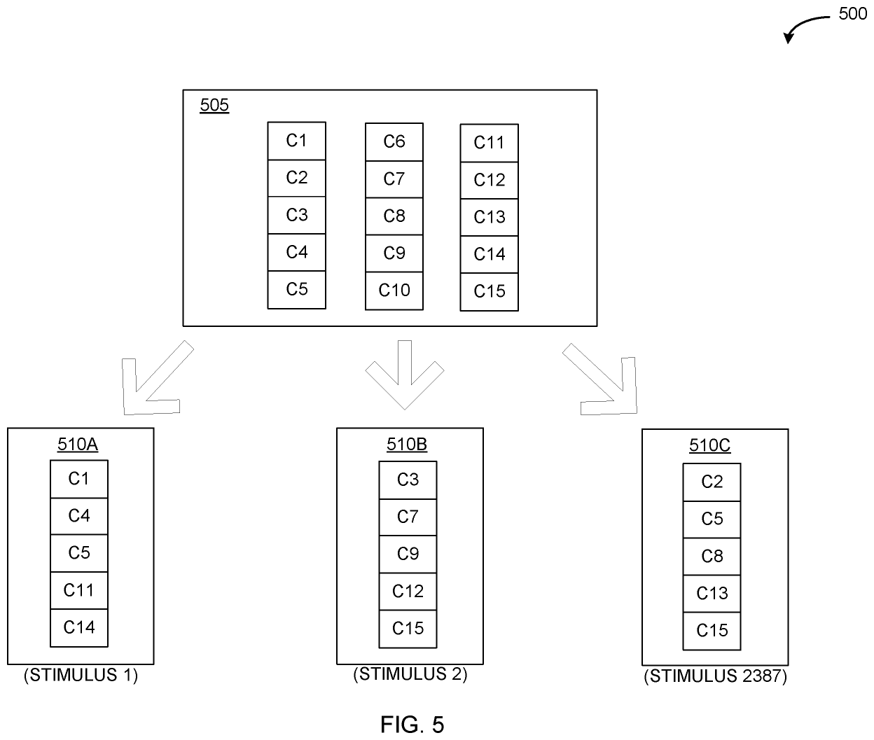

FIG. 5 is an example of a broad topic described in terms of components on the broad tropic. Component environment 500 includes a broad topic that is the base stimulus and the generated shorter stimuli composed of some of the components from the broad topic. For example, if broad topic 505 is “Venice”, then the larger initial set of components could individually deal (in text, tables, illustrations, etc.) with various aspects of “Venice” (e.g., C1-C15). These aspects, for example, include the etymology of the name, various periods in its history, its geography, its government, its economy, transportation, sport, education, demographics, and culture (e.g., literature, art, architecture, festivals, music, and cuisine), notable people, and international relations). Assessment module 105 selects 5 components from the 15-componenet broad topic 505 to generate 3003 possible arrangement of the 5 components. In FIG. 5, stimulus 1 is the first possible arrangement, which is depicted as generated stimulus 510A; stimulus 2 is the second possible arrangement, which is depicted as generated stimulus 510B; and stimulus 2387 is two thousand-three hundred-eighty-seventh possible arrangement, which is depicted as stimulus 510C. Generated stimulus 510A contains components C1, C4, C5, C11, and 14; generated stimulus 510B contains components C3, C7, C9, C12, and C15; and generated stimulus 510C contains components C2, C5, C8, C13, and C15.

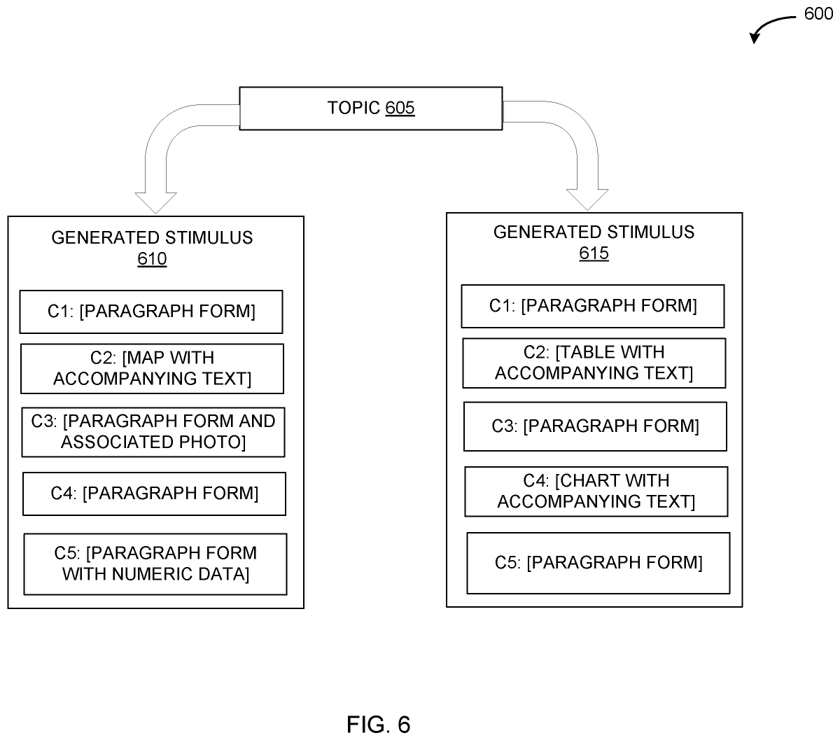

FIG. 6 is an example of generated stimuli containing different arrangements of components. Component environment 600 illustrates the adaptability of assessment module 105. For example, topic 605 is the broad topic treated as the base stimulus. The shorter stimulus generated from the base stimulus are: generated stimulus 610 and generated stimulus 615. Both generated stimulus 610 and generated stimulus 615 contain 5 components each. The components may be edited for desired length, language, etc. Each component would have associated items as accompanying test questions, which are not depicted in FIG. 6.

For example, topic 605 is “Venice” and the shorter stimulus generated are: generated stimulus 610 and generated stimulus 615, which contain sub-topics pertinent to “Venice”. In generated stimulus 610, C1 is in paragraph form (i.e., contents are merely in textual form); C2 is a map with accompanying text; C3 is in paragraph form and has an associated photo; C4 is in paragraph form; and C5 is in paragraph form while containing numerical data. In generated stimulus 615, C1 is in paragraph form (i.e., contents are merely in textual form); C2 is a table with accompanying text; C3 is in paragraph form; C4 is a chart with accompanying text; and C5 is in paragraph form.

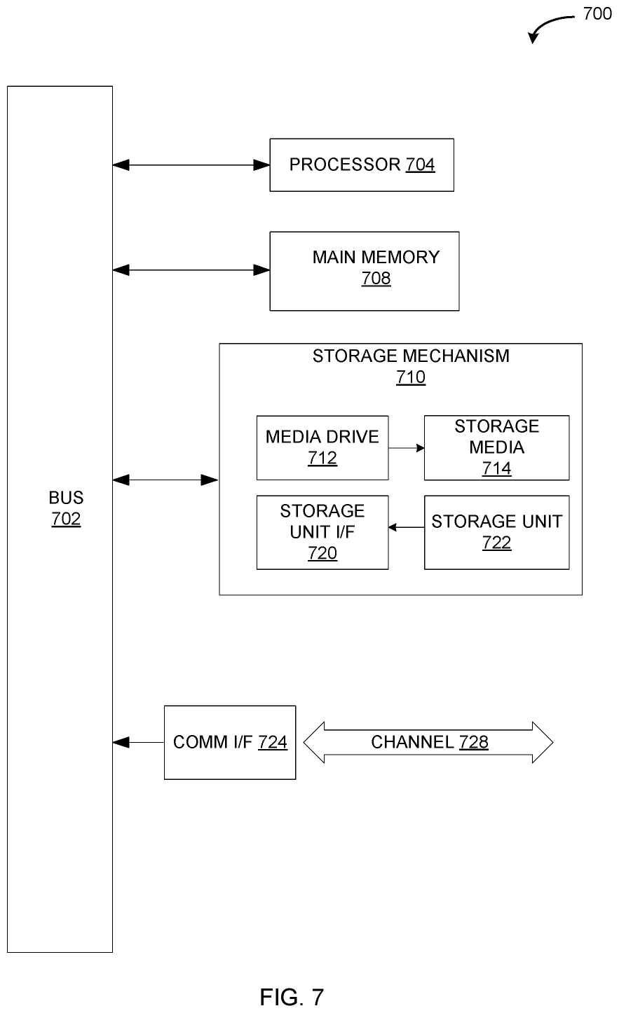

The content of the paragraph forms varies across generated stimulus 610 and generated stimulus 615. More specifically, C1 in generated stimulus 610 is a paragraph pertaining to the founders of Venice, whereas C1 in generated stimulus 615 is a paragraph pertaining to transportation in Venice. C2 in generated stimulus 610 pertains to the geography of Venice while also depicting a map of the boroughs of Venice, whereas C2 in generated stimulus 615 pertains to demographic information of Venice in tabular format containing population data of Venice over the decades. C3 in generated stimulus 610 pertains to the cuisine of Venice while also depicting a custom of drinking hot chocolate during 1770s Venice in a candid painting, whereas C3 in generated stimulus 615 pertains to art and printing in Venice during the Middle Ages and Renaissance periods. C4 in generated stimulus 610 pertains to the music of Venice, whereas C4 in generated stimulus 615 pertains to climate data of Venice depicted in chart format. C5 in generated stimulus 610 pertains to demographic information of Venice with population data, whereas C4 in generated stimulus 615 pertains to the economy of Venice. Stated another way, a wide array of sub-topics may be automatically generated using assessment module 105, as depicted in FIG. 6.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 7. Various embodiments are described in terms of this example logical circuit 700. After reading this description, it will become apparent to a person skilled in the relevant art how to implement the technology using other logical circuits or architectures.

Referring now to FIG. 7, computing system 700 may represent, for example, computing or processing capabilities found within desktop, laptop, and notebook computers; hand-held computing devices (PDA's, smart phones, cell phones, palmtops, etc.); mainframes, supercomputers, workstations, or servers; or any other type of special-purpose or general-purpose computing devices as may be desirable or appropriate for a given application or environment. Logical circuit 700 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 700 might include, for example, one or more processors, controllers, control engines, or other processing devices, such as a processor 404. Processor 404 might be implemented using a general-purpose or special-purpose processing engine such as, for example, a microprocessor, controller, or other control logic. In the illustrated example, processor 704 is connected to a bus 702, although any communication medium can be used to facilitate interaction with other components of logical circuit 700 or to communicate externally.

Computing system 700 might also include one or more memory engines, simply referred to herein as main memory 708. For example, preferably random-access memory (RAM) or other dynamic memory, might be used for storing information and instructions to be executed by processor 704. Main memory 708 might also be used for storing temporary variables or other intermediate information during execution of instructions to be executed by processor 704. Logical circuit 700 might likewise include a read only memory (“ROM”) or other static storage device coupled to bus 702 for storing static information and instructions for processor 704.

The computing system 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), or other removable or fixed media drive might be provided. Accordingly, storage media 714 might include, for example, a hard disk, a floppy disk, magnetic tape, cartridge, optical disk, a CD or DVD, or other fixed or removable medium that is read by, written to, or accessed by media drive 712. As these examples illustrate, the storage media 714 can include a computer usable storage medium having stored therein computer software or data.

In alternative embodiments, information storage mechanism 740 might include other similar instrumentalities for allowing computer programs or other instructions or data to be loaded into logical circuit 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory engine) and memory slot, a PCMCIA slot and card, and other fixed or removable storage units 722 and interfaces 720 that allow software and data to be transferred from the storage unit 722 to logical circuit 700.

Logical circuit 700 might also include a communications interface 724. Communications interface 724 might be used to allow software and data to be transferred between logical circuit 700 and external devices. Examples of communications interface 724 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 700 to perform features or functions of the disclosed technology as discussed herein.

Although FIG. 7 depicts a computer network, it is understood that the disclosure is not limited to operation with a computer network, but rather, the disclosure may be practiced in any suitable electronic device. Accordingly, the computer network depicted in FIG. 7 is for illustrative purposes only and thus is not meant to limit the disclosure in any respect.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical, or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more”, “at least”, “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for improving customization of automated generation of stimulus-based assessment pertaining to a topic, the method comprising:
connecting, by an access logical circuit, to one or more information sources;
extracting, by an analytics logical circuit, a set of contents from the one or more information sources;
dividing, by a faceting logical circuit, the extracted set of contents into a first number of components and a second number of components, wherein the first number of components is larger than the second number of components;
extracting, by the faceting logical circuit, one or more questions from the one or more information sources, wherein the extracted one or more questions are directed to the extracted set of contents;
receiving, at a first graphical user interface, a base stimulus, wherein the base stimulus contains the first number of components with the topic and a first set of questions of the extracted one or more questions associated with each component of the first number of components;
generating, by the analytics logical circuit, sub-stimuli to the base stimulus, wherein the sub-stimuli contain the second number of components and a second set of questions of the extracted one or more questions associated with each component of the second number of components;
transmitting, by an assessment logical circuit, the selected sub-stimulus components and the extracted one or more questions to a second graphical user interface; and
displaying, at the second graphical user interface, the selected sub-stimulus components and the second set of questions to examinees.

2. The method of claim 1, further comprises:
modifying, by the analytics logical circuit, the extracted set of contents by editing at least one of: a length and a language of the set of extracted contents.

3. The method of claim 1, wherein each of the questions is characterized as having low, medium, or high difficulty, based on determinations made by the analytics logical circuit.

4. The method of claim 1, wherein the first number of components and the second number of components are in a textual, numerical, visual, or an audio format.

5. The method of claim 1, wherein a desired number of sub-stimuli is configured in the first graphical user interface.

6. The method of claim 1, further comprises:
rearranging, by the faceting logical circuit, the extracted set of contents from the one or more information sources; and
modifying, by the faceting logical circuit, the first set of components and the second set of components, in response to rearranging the extracted set of contents.

7. The method of claim 1, wherein a total number of possible sub-stimuli is computed by:
[(The First Number of Components)!]/[(The First Number of Components−The Second Number of Components)!(The Second Number of Components)!].

8. A computer program product for improving customization of automated generation of stimulus-based assessment pertaining to a topic, the computer program product comprising:
a computer readable storage medium;
program instructions stored on the computer readable storage medium comprising:
program instructions to connect to one or more information sources, by an access logical circuit;
program instructions to extract a set of contents from the one or more information sources, by an analytics logical circuit;
program instructions to divide the extracted set of contents into a first number of components and a second number of components, wherein the first number of components is larger than the second number of components, by a faceting logical circuit;
program instructions to extract one or more questions from the one or more information sources by the faceting logical circuit, wherein the extracted one or more questions are directed to the set of extracted contents;
program instructions to receive a base stimulus at a first graphical user interface, wherein the base stimulus contains the first number of components with the topic and a first set of questions of the extracted one or more questions associated with each component of the first number of components;
program instructions to generate sub-stimuli from the base stimulus, by the analytics logical circuit, wherein the sub-stimuli contain the second number of components and a second set of questions of the extracted one or more questions associated with each component of the second number of components;
program instructions to send the selected sub-stimulus components and associated questions to a second graphical user interface, by an assessment logical circuit; and
program instructions to display the selected sub-stimulus components and the second set of questions to examinees, at the second graphical user interface.

9. The computer program product of claim 8, further comprising:
program instructions to modify the extracted set of contents by editing at least one: a length and a language of the extracted set of contents, by the analytics logical circuit.

10. The computer program product of claim 8, wherein each of the questions is characterized as having low, medium, or high difficulty, based on determinations made by the analytics logical circuit.

11. The computer program product of claim 8, wherein the first number of components and the second number of components are in a textual, numerical, visual, or an audio format.

12. The computer program product of claim 8, wherein a desired number of sub-stimuli is configured in the first graphical user interface.

13. The computer program product of claim 8, further comprises:
program instructions to rearrange the extracted set of contents from the one or more information sources, by the faceting logical circuit; and
program instructions to modify the first set of components and the second set of components, in response to rearranging the extracted set of contents, by the faceting logical circuit.

14. A computer system for improving customization of generation of stimulus-based assessment pertaining to a topic, the computer system comprising:
one or more computer processors;
one or more computer readable storage media;
program instructions stored on the one or more computer readable storage media for execution by at least one of the one or more processors, the program instructions comprising:
program instructions to connect to one or more information sources, by an access logical circuit;
program instructions to extract a set of contents from the one or more information sources, by an analytics logical circuit;
program instructions to divide the extracted set of contents into a first number of components and a second number of components, wherein the first number of components is larger than the second number of components, by a faceting logical circuit;
program instructions to extract one or more questions from the one or more information sources by the faceting logical circuit, wherein the extracted one or more questions are directed to the extracted set of contents;
program instructions to receive a base stimulus at a first graphical user interface, wherein the base stimulus contains the first number of components with the topic and a first set of questions of the extracted one or more questions associated with each component of the first number of components;
program instructions to generate sub-stimuli from the base stimulus, by the analytics logical circuit, wherein the sub-stimuli contain the second number of components and a second set of questions of the extracted one or more questions associated with each component of the second number of components;
program instructions to send the selected sub-stimulus components and associated questions to a second graphical user interface, by an assessment logical circuit; and
program instructions to display the selected sub-stimulus components and the second set of questions to examinees, at the second graphical user interface.

15. The computer system of claim 14, further comprising:
program instructions to modify the extracted set of contents by editing at least one of: a length and a language of the extracted set of contents, by the analytics logical circuit.

16. The computer system of claim 14, wherein each of the questions is characterized as having low, medium, or high difficulty, based on determinations made by the analytics logical circuit.

17. The computer system of claim 14, wherein the first number of components and the second number of components in a textual, numerical, visual, or an audio format.

18. The computer system of claim 14, wherein a desired number of sub-stimuli is configured in the first graphical user interface.

19. The computer system of claim 14, further comprises:
program instructions to rearrange the extracted set of contents from the one or more information sources, by the faceting logical circuit; and
program instructions to modify the first set of components and the second set of components, in response to rearranging the extracted set of contents, by the faceting logical circuit.

20. The computer system of claim 14, wherein a total number of possible sub-stimuli is computed by:
[(The First Number of Components)!]/[(The First Number of Components−The Second Number of Components)!(The Second Number of Components)!].
